(19) United States
(12) Patent Application Publication
(10) Pub. No.: US 2026/0017901 A1
(43) Pub. Date: Jan. 15, 2026

(54) METHODS AND SYSTEMS FOR ECOSYSTEM ENCAPSULATOR DEVICE TO MANAGE MULTI-LAYERED ECOSYSTEM RESPONSES

(71) Applicant: US TECHNOLOGY INTERNATIONAL PRIVATE LIMITED, Thiruvananthapuram (IN)

(72) Inventor: Jaison Joseph SEBASTIAN, Trivandrum (IN)

(21) Appl. No.: 19/332,874

(22) Filed: Sep. 18, 2025

Related U.S. Application Data
(63) Continuation-in-part of application No. 18/073,279, filed on Dec. 1, 2022, now Pat. No. 12,445,824.

(30) Foreign Application Priority Data
Sep. 22, 2022 (IN) 202241054417
Aug. 6, 2025 (IN) 202543074965

(51) Int. Cl. G06T 19/00; G06F 3/01; G06N 3/08; H04L 9/00

(52) U.S. Cl. CPC G06T 19/006; G06F 3/011; G06N 3/08; G06T 19/003; H04L 9/50; G06T 2219/004; G06T 2219/012

(57) ABSTRACT

Disclosed herein is a method implemented on an ecosystem encapsulator device communicably coupled to a blockchain network, for managing multi-layered ecosystem responses to predefined events is disclosed. The method includes generating a plurality of ecosystem layers around a subject node on a metaverse object and determining a plurality of subject parameters based on a sensing device input. Furthermore, the method includes detecting an event associated with the subject node based on at least one subject parameter and triggering, based on the detected event, at least one transaction across the one or more entity nodes in a corresponding ecosystem layer. Further, the method includes determining one or more dimensional parameters associated with the detected event for the at least one triggered transaction and generating a multi-dimensional annotation with the metaverse object based on the at least one triggered transaction and corresponding dimensional parameters.

### TECHNICAL FIELD

The present disclosure relates to an ecosystem encapsulator device, and more particularly, relates to methods and systems for an ecosystem encapsulator device to manage multi-layered ecosystem responses.

### BACKGROUND

In contemporary society, a demand for integrated service platforms has grown significantly due to the increasing complexity of urban living, technological advancement, and the need for rapid, reliable access to diverse services. Individuals and organizations alike require seamless access to utilities ranging from healthcare, transportation, logistics, and financial services to emergency response and public safety. Traditionally, such services have been offered in silos, resulting in fragmented user experiences, inefficiencies in service delivery, and delays in critical situations.

The concept of a multi-service ecosystem has emerged as a solution to these challenges. Such ecosystems are designed to unify various service domains under a common framework, enabling interoperability, data sharing, and coordinated service execution. The ecosystems leverage digital platforms, cloud infrastructure, and intelligent data processing to facilitate real-time service orchestration and user engagement.

Despite the progress in digital service platforms, there remains a critical gap in the integration of emergency response mechanisms within the ecosystems. The emergency services, such as medical aid, fire response, disaster management, and law enforcement, require immediate, context-aware, and location-specific interventions. The lack of a dedicated emergency response layer within existing service ecosystems often leads to delayed reactions, miscommunication among service providers, and suboptimal outcomes during crises.

A key limitation lies in the absence of a quantitative and relational model to assess and operationalize the inter-service interactions required during emergencies. There is a need for a solution, where each element quantifies the dependency, responsiveness, and coordination strength between any two services. Such a solution would support emergency-centric decision-making and dynamic response planning,

Additionally, existing platforms lack does not allow modular and hierarchical emergency orchestration. A robust emergency-integrated ecosystem would benefit from multiple interoperable layers including data collection, context analysis, prioritization logic, and execution control to enable real-time, context-aware emergency handling.

Therefore, there is a pressing need for an ecosystem architecture that incorporates layered service modules, including a specialized emergency response layer.

### SUMMARY

This summary is provided to introduce a selection of concepts, in a simplified format, that are further described in the detailed description of the invention. This summary is neither intended to identify key or essential inventive concepts of the invention nor to determine the scope of the invention.

According to an embodiment of the present disclosure, a method implemented on an ecosystem encapsulator device communicably coupled to a blockchain network, for managing multi-layered ecosystem responses to predefined events is disclosed. The method includes generating a plurality of ecosystem layers around a subject node on a metaverse object. Each of the plurality of ecosystem layers includes one or more entity nodes. Further, the method includes determining a plurality of subject parameters associated with the subject node based on a sensing device input. The subject parameters indicate one or more of physiological, behavioral, or contextual states of the subject node. Furthermore, the method includes detecting an event associated with the subject node based on at least one subject parameter from among the plurality of subject parameters. Moreover, the method includes triggering, based on the detected event, at least one transaction across the one or more entity nodes in a corresponding ecosystem layer in the plurality of ecosystem layers. The at least one transaction indicates a responsive action, communication, or resource exchange initiated among the one or more entity nodes. Further, the method includes determining one or more dimensional parameters associated with the detected event for the at least one triggered transaction. Furthermore, the method includes generating a multi-dimensional annotation with the metaverse object based on the at least one triggered transaction and corresponding dimensional parameters. The multi-dimensional annotation indicates a cryptographically linked visual representation, thereby ensuring integrity and traceability of visualized multi-layered ecosystem on the blockchain network.

According to an embodiment of the present disclosure, a system implemented on an ecosystem encapsulator device communicably coupled to a blockchain network 110, for managing multi-layered ecosystem responses to predefined events is disclosed. The system includes one or more processors and a memory coupled with the one or more processors. The one or more processors are configured to generate a plurality of ecosystem layers around a subject node on a metaverse object 108. Each of the plurality of ecosystem layers includes one or more entity nodes. Further, the one or more processors are configured to determine a plurality of subject parameters associated with the subject node based on a sensing device input. The subject parameters indicate one or more of physiological, behavioral, or contextual states of the subject node. Furthermore, the one or more processors are configured to detect an event associated with the subject node based on at least one subject parameter from among the plurality of subject parameters. Moreover, the one or more processors are configured to trigger, based on the detected event, at least one transaction across the one or more entity nodes in a corresponding ecosystem layer in the plurality of ecosystem layers. The at least one transaction indicates a responsive action, communication, or resource exchange initiated among the one or more entity nodes. Further, the one or more processors are configured to determine one or more dimensional parameters associated with the detected event for the at least one triggered transaction. Furthermore, the one or more processors are configured to generate a multi-dimensional annotation with the metaverse object based on the at least one triggered transaction and corresponding dimensional parameters. The multi-dimensional annotation indicates a cryptographically linked visual representation, thereby ensuring integrity and traceability of visualized multi-layered ecosystem on the blockchain network.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example environment for an implementation of a system for managing multi-layered ecosystem responses to predefined events, in accordance with an embodiment of the present disclosure;

FIG. 2 illustrates a block diagram of the system, in accordance with an embodiment of the present disclosure;

FIG. 3 illustrates an exemplary view of one or more entity nodes of the system, according to an embodiment of the present disclosure;

FIGS. 4A-4D illustrate an exemplary exploded view of multi-layered ecosystem, according to an embodiment of the present disclosure;

FIG. 5 illustrates a system architecture depicting an artificial neural network (ANN) in metaverse, a and an event network on the metaverse, according to an embodiment of the present disclosure; and

FIGS. 6A-6B illustrate a process flow of a method for managing multi-layered ecosystem responses to the predefined events, according to an embodiment of the present disclosure.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment, to several embodiments, or to all embodiments. Accordingly, the term “some embodiments” is defined as meaning “no embodiment, or one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility, and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “a further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment or may be found in more than one embodiment, or may be found in all embodiments, or may be found in no embodiments.

Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any feature and/or element described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Embodiments of the present disclosure will be described below in detail with reference to the accompanying drawings.

Further, skilled artisans will appreciate that those elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

The present disclosure provides methods and systems for an ecosystem encapsulator device to manage multi-layered ecosystem responses. The present disclosure provides optimized utilization of time and resources in scenarios where time is of the essence and increases effectiveness of communication and/or services initiated with minimal human intervention.

It is an object of the invention to provide a method and a system that overcomes the limitations found in prior art related to managing multi-layered ecosystem responses to predefined events.

It is another object of the invention to associate multiple dimensions with each event trigger represented in a metaverse, enabling rich contextualization, enhanced interactivity, and deeper semantic understanding of user experiences.

It is another object of the invention to generate a multi-dimensional annotation for a metaverse object.

It is another object of the invention to facilitate a user to interact with the plurality of ecosystem layers on the metaverse to trigger at least one transaction.

It is yet another object of the invention to introduce a new capability within the ecosystem layer into the metaverse.

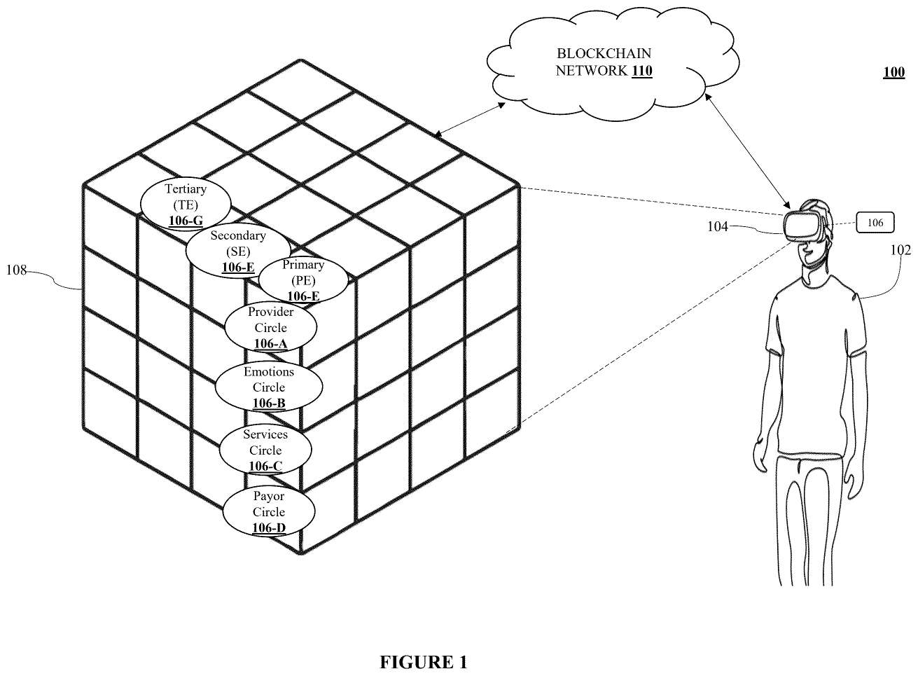

FIG. 1 illustrates an example environment 100 for an implementation of a system 106 for managing multi-layered ecosystem responses to predefined events, in accordance with an embodiment of the present disclosure.

As shown, the environment 100 may include a user 102 (alternately referred to hereinafter as “subject node”) using an ecosystem encapsulator device 104 that communicates with a blockchain network 108. A system 106 may be implemented in the ecosystem encapsulator device 104 and is configured to manage multi-layered ecosystem responses to the predefined events. Further, the ecosystem encapsulator device 104 may be communicably coupled to the blockchain network 110.

In a non-limiting example, the multi-layered ecosystem (alternately referred to hereinafter as “ecosystem layer” or “plurality of ecosystem layers”) may correspond to a structured and interdependent arrangement of digital and/or physical components organized across two or more functional layers. Each functional layer may represent a distinct operational domain, such as data acquisition, processing, interaction, communication, or governance, and may be configured to perform specialized tasks in response to the predefined events. The multi-layered ecosystem may include, but is not limited to, user interfaces, embedded devices, network infrastructures, blockchain systems, artificial intelligence modules, and metaverse environments. Further, interactions between functional layers may be facilitated through defined protocols, enabling coordinated responses, adaptive behaviors, and dynamic resource allocation across the ecosystem.

In a non-limiting example, the predefined events (alternately referred to hereinafter as “event”) may correspond to one or more occurrences, conditions, or triggers that are specified in advance within a system architecture or operational framework. For instance, the predefined events may be defined based on temporal parameters, user actions, system states, environmental inputs, or external signals, and may be stored in one or more data structures, rule sets, or configuration files. The predefined events may initiate, modify, or terminate one or more processes, responses, or interactions within the multi-layered ecosystem. In an embodiment, the predefined events may be dynamically updated or extended based on contextual learning, user preferences, or system feedback.

In a non-limiting example, the environment 100 may correspond to a digitally simulated or physically integrated operational context comprising one or more users interacting with a metaverse object 108. Further, the environment 100 may be virtual, augmented, or mixed reality interfaces, network infrastructure, and associated computational resources necessary to support immersive and decentralized interactions.

In a non-limiting example, the ecosystem encapsulator device 104 may correspond to various devices such as a head mounted display (HMD) device, an augmented reality (AR) glasses, a personal computer (PC), a tablet PC, a personal digital assistant (PDA), a mobile device, a palmtop computer, a laptop computer, a desktop computer, a communications device, dashboard, navigation device, a computing device, or any other machine capable of executing a set of instructions. The ecosystem encapsulator device 104 may serve as access points for rendering context-aware information, receiving user inputs, displaying real-time status updates, and facilitating interactive control of services within the ecosystem. As an example, but not limited to, the network may be a blockchain network 110, metaverse network, and the like.

In a non-limiting example, the blockchain network 110 may be a metaverse network and the like.

In an embodiment, the system 106 may be implemented in various hardware configurations to meet different operational environments. In one embodiment, the system 106 may be implemented as a dedicated embedded device tailored with real-time processing capabilities and custom firmware to handle rapid, localized decisions without relying on cloud infrastructure. In another embodiment, the system 106 may be implemented as software as a service within a distributed cloud architecture, allowing for dynamic scaling and integration with broader data analytics platforms or digital twins. In yet another embodiment, the system 106 may be implemented through a hybrid Internet of Things (IoT) gateway model, combining both embedded hardware and containerized microservices.

In an embodiment, the system 106 may include one or more software components, one or more hardware components, or a combination thereof. The system 106 may also include an in-built application or an application to be installed and operated on the handheld electronic devices in communication with a network interface (not shown). The system 106 may also be available via a cloud-based server.

Further, in an embodiment, the network interface (not shown) may be configured to provide network connectivity and enable communication between the system 106 and the ecosystem encapsulator device 104. The network connectivity may be provided via a wireless connection or a wired connection. For example, the network connectivity may be provided via cellular technology, such as 3rd Generation (3G), 4th Generation (4G), 5th Generation (5G), pre-5G, 6th Generation (6G), Bluetooth, Local Area Network (LAN), Wireless Fidelity (Wi-Fi), cable, or any other wired or wireless communication technology.

In an embodiment, the system 106 may be configured to generate the plurality of ecosystem layers 106-E, 106-F, and 106-G around a subject node on a metaverse object 108. In a non-limiting example, each of the plurality of ecosystem layers 106-E, 106-F, and 106-G may include one or more entity nodes 106-A, 106-B, 106-C, and 106-D.

In a non-limiting example, the subject node may correspond to a designated digital entity, data point, or interaction anchor within the metaverse object 108 that serves as a focal point for generating or associating ecosystem layers. The subject node may be a user avatar, virtual asset, interaction event, or computational process, and is configured to receive, transmit, or process data across the plurality of ecosystem layers 106-E, 106-F, and 106-G.

In an embodiment, the metaverse object 108 may correspond to a digitally instantiated entity within a simulated, immersive, or extended reality environment. For instance, the metaverse object 108 may include, but is not limited to, avatars, virtual assets, interactive elements, spatial constructs, or encoded digital tokens.

In a non-limiting example, the one or more entity nodes 106-A, 106-B, 106-C, and 106-D may correspond to a digitally represented functional unit within a system architecture that is configured to perform one or more roles in response to the predefined event. Each of the one or more entity nodes 106-A, 106-B, 106-C, and 106-D may correspond to a distinct stakeholder, service, or data source within the plurality of ecosystem layers 106-E, 106-F, and 106-G, and may be operable to transmit, receive, process, or store information relevant to the predefined event context. In an embodiment, each entity node 106-A, 106-B, 106-C, and 106-D may be dynamically linked to the subject node and may participate in generating or interacting with the plurality of ecosystem layers 106-E, 106-F, and 106-G on the metaverse object 108.

In an example scenario, for the predefined event related to a health disorder, the one or more nodes associated with emergency medical services, healthcare providers, and contextual service entities that may be triggered to execute coordinated response actions based on the detected parameters. The one or more nodes may include at least one of:

a) Care Provider Node: An entity node that may correspond to a healthcare professional, institution, or service configured to deliver medical care, diagnostics, or therapeutic interventions.
b) Service Provider Node: An entity node that may be associated with auxiliary services such as diagnostics, logistics, telehealth platforms, or wellness applications.
c) Payor Node: An entity node that may correspond to an insurance provider, government agency, or financial institution responsible for processing claims, reimbursements, or coverage determinations.
d) Social Network Node: An entity node may be configured to facilitate peer-to-peer communication, support groups, or community engagement relevant to the health disorder.
e) Peer Patient Node: An entity node that may correspond to individuals with similar health conditions, configured to share experiences, data, or support within the ecosystem.

Further, in a non-limiting example, the metaverse object 108 may comprise an n×n dimensional encapsulated 3D structure configured to represent the plurality of ecosystem layers 106-E, 106-F, and 106-G and interconnections among the one or more entity nodes 106-A, 106-B, 106-C, and 106-D. In a non-limiting example, user may interact with the n×n dimensional 3D structure within the metaverse. The structure may represent multiple ecosystem layers and the intersections of the multiple ecosystem layers across various dimensions. In the non-limiting example, the user may utilize a virtual scissor tool to slice and dice the structure, thereby enabling selective access to specific regions of interest. Upon such interaction, the system 106 may generate artificial intelligence (AI)-annotated summary of accessed segments or layers, which may include analytical insights and contextual information. In the non-limiting example, the user may also access encrypted data corresponding to selected layers stored and retrieved via a blockchain-based ledger to ensure secure and verifiable access. Furthermore, the user may also access neural network elements linked to emergency events associated with the subject node, allowing for dynamic analysis and responsive action within the ecosystem.

In an embodiment, the system 106 may be configured to determine a plurality of subject parameters associated with the subject node based on a sensing device input. In a non-limiting example, the subject parameters may indicate one or more of physiological, behavioral, or contextual states of the subject node.

In a non-limiting example, a sensing device may comprise at least one of a wearable biometric sensor, a video capture device, a voice recognition device, or an environmental monitor communicably coupled to the ecosystem encapsulator device 104.

In an embodiment, the system 106 may be configured to detect an event associated with the subject node based on at least one subject parameter from among the plurality of subject parameters.

In an embodiment, the system 106 may be configured to trigger, based on the detected event, at least one transaction across the one or more entity nodes in a corresponding ecosystem layer in the plurality of ecosystem layers 106-E, 106-F, and 106-G. In a non-limiting example, the at least one transaction indicates a responsive action, communication, or resource exchange initiated among the one or more entity nodes 106-A, 106-B, 106-C, and 106-D.

In an embodiment, the system 106 may be configured to determine one or more dimensional parameters associated with the detected event for the at least one triggered transaction. In a non-limiting example, the one or more dimensional parameters may comprise at least one of a cohort identifier, a key performance indicator (KPI), a service level score, a risk level, and a metaverse interaction point value.

In an embodiment, the system 106 may be configured to generate a multi-dimensional annotation with the metaverse object 108 based on the at least one triggered transaction and corresponding dimensional parameters. In a non-limiting example, the multi-dimensional annotation may indicate a cryptographically linked visual representation thereby ensuring integrity and traceability of visualized multi-layered ecosystem on the blockchain network 110.

In an embodiment, the system 106 may be configured to generate a hash of the at least one triggered transaction and the corresponding dimensional parameters. In a non-limiting example, the hash may indicate a cryptographically verifiable reference to the event, ensuring data integrity and non-repudiation.

In an embodiment, the system 106 may be configured to store the hash on the blockchain network 110 to register the predefined event.

In an embodiment, to determine the plurality of subject parameters, the system 106 may be configured to receive at least one of temporal or spatial data captured by the sensing device. Further, the system 106 may be configured to determine at least one of a biometric signal, a behavioral pattern, or an environmental condition associated with the subject node based on the at least one of temporal or spatial data.

In an example scenario, the subject node, for instance, the user, may participate in or access a wellness-focused ecosystem. The system 106 may receive temporal data (for instance, time-stamped activity logs) and spatial data (for instance, geolocation or movement patterns) from the sensing device. Based on the received data, the system 106 may determine the plurality of subject parameters, for instance, elevated heart rate, reduced physical activity over a defined period, and high ambient temperature. The plurality of subject parameters may be used to assess the user's current health status and trigger a predefined event, such as initiating a virtual consultation with a care provider node or generating a personalized wellness recommendation within the metaverse object 108.

In an embodiment, the system 106 may be configured to receive an interaction from a subject. In a non-limiting example, the interaction may indicate visualization, filtering, or navigation through the multi-dimensional annotation based on selected dimensional parameters or a time sequence of triggered transactions in the metaverse object 108. In a non-limiting example, the subject may correspond to a human user, digital agent, or autonomous entity that engages with one or more components of the multi-layered ecosystem.

In an embodiment, the system 106 may be configured to receive a modification from the subject. In a non-limiting example, the modification may indicate adjusting the transaction context represented in the multi-dimensional annotation on the metaverse object 108. Further, the system 106 may be configured to manage one or more neural network variables, connections, or weight values associated with the plurality of ecosystem layers of an artificial neural network (ANN) configured within the ecosystem encapsulator device to modify the transaction context. In an embodiment, the ANN may include a plurality of interconnected nodes, each representing an element such as a micro cohort, service, risk factor, or contextual parameter. The nodes may be linked by weighted edges, where each weight may denote an influence value or a prioritization metric that may govern the propagation of data or decision logic within the network or the ecosystem. In an embodiment, the neural network's variables and weight values are dynamically adjustable by the user or the administrator node, enabling real-time reconfiguration of the ANN to support subject-specific responses and adaptive transaction flows. In an embodiment, the system 106 may be configured to generate a new capability for the one or more entity nodes within the corresponding ecosystem layer. Further, the system 106 may be configured to update the metaverse object 108 and the corresponding dimensional parameters, thereby reflecting an improved service level of the one or more entity nodes.

In an advantageous aspect, the user (or the subject) may be able to introduce new elements into the metaverse. For instance, the user may add new capabilities in the metaverse such as technical, functional, and financial, to facilitate improved service levels.

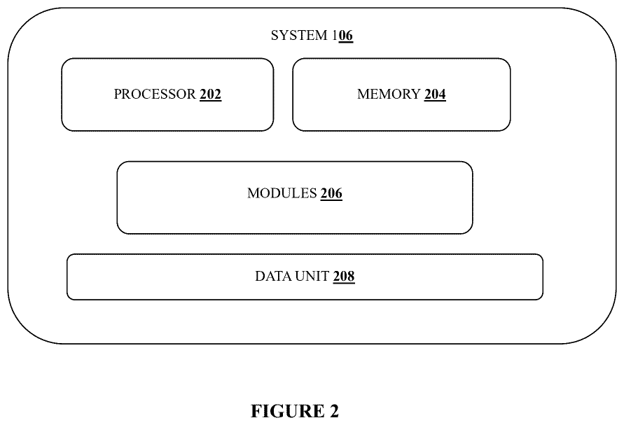

FIG. 2 illustrates a block diagram of the system 106, in accordance with an embodiment of the present disclosure In an embodiment, the system 104 may include, but is not limited to, at least one processor 202 (alternately referred hereinafter as a processing unit 202 or the processor 202), a memory 204, one or more modules 206, and a data unit 208. The one or more modules 206 and the memory 204 may be coupled to the processor 202.

The processor 202 can be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU) and a large language processing unit (LPU) as well. One or a plurality of processors control the processing of the input data in accordance with a predefined operating rule or artificial intelligence (AI) model stored in the non-volatile memory and the volatile memory.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The predefined configuration may be stored in the memory 204.

The one or more modules 206, amongst other things, include routines, programs, objects, components, data structures, etc., which perform particular tasks or implement data types. The one or more modules 206 may also be implemented as, signal processor(s), state machine(s), logic circuitries, and/or any other device or component that manipulates signals based on operational instructions.

Further, the one or more modules 206 can be implemented in hardware, instructions executed by a processing unit, or by a combination thereof. The processing unit can comprise a computer, a processor, a state machine, a logic array, or any other suitable devices capable of processing instructions. The processing unit can be a general-purpose processor that executes instructions to cause the general-purpose processor to perform the required tasks, or the processing unit can be dedicated to performing the required functions. In another embodiment of the present disclosure, the processor 202 via the one or more modules 206 is configured to execute machine-readable instructions (software) that perform the working of the system 104 within the scope of the present disclosure as described in forthcoming paragraphs.

In an embodiment, the data unit 208 serves, amongst other things, as a repository for storing data processed, received, and generated by the one or more modules 206.

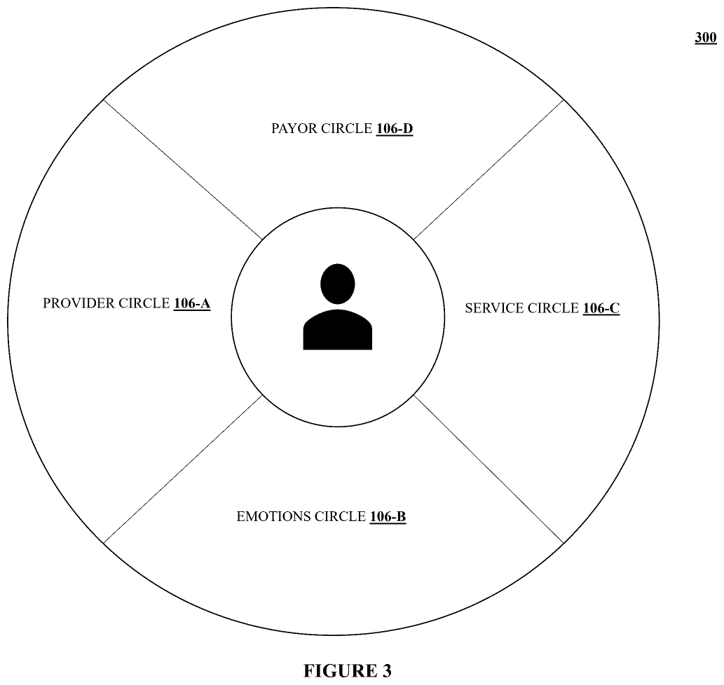

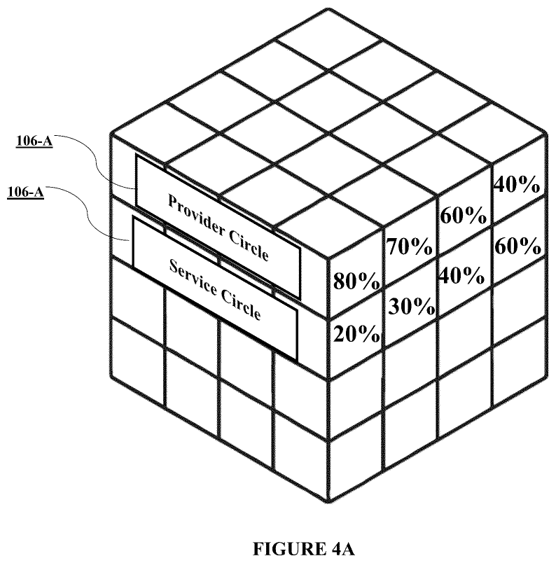

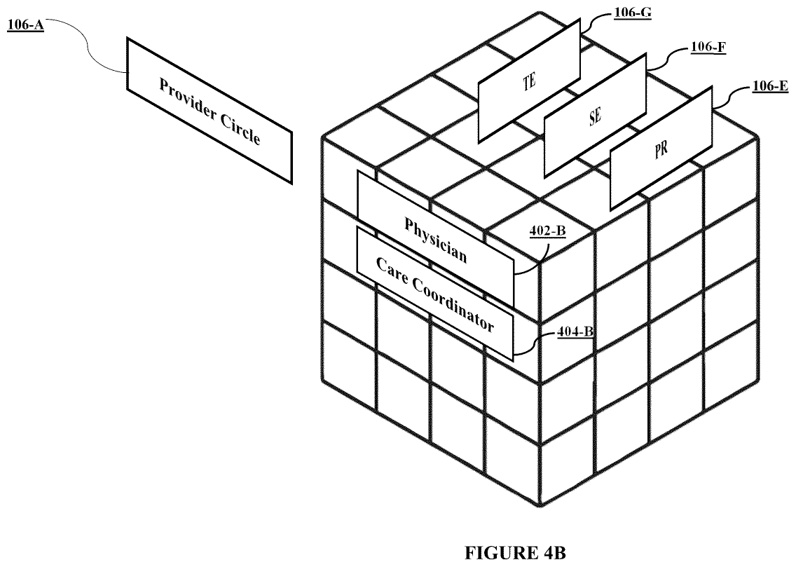

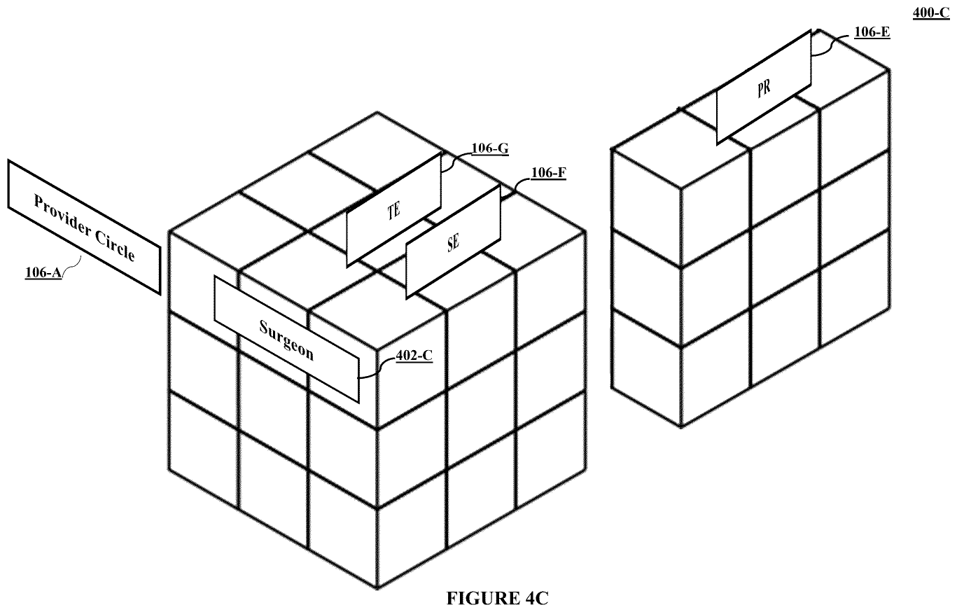

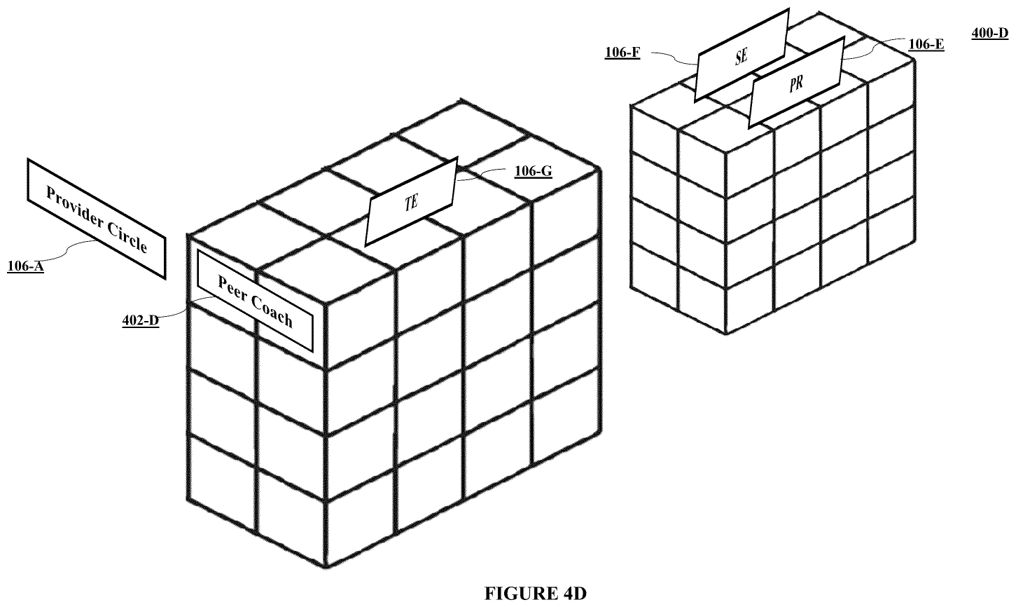

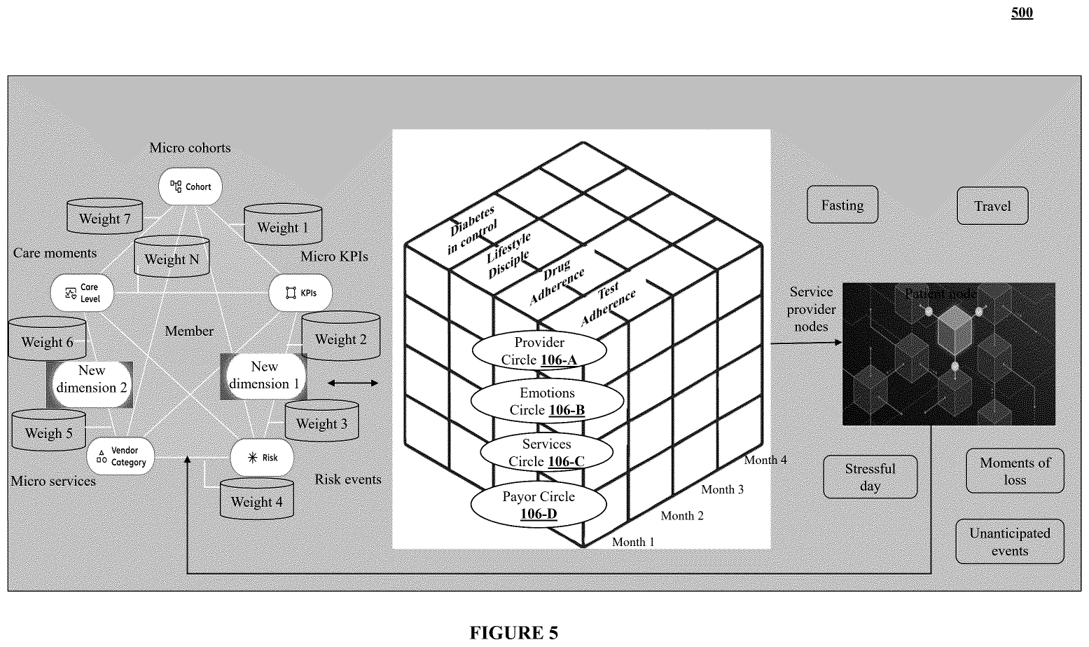

A detailed working and explanation of the system 104 will be explained through various components of FIG. 3, FIGS. 4A-4D, and FIG. 5 in the forthcoming paragraphs. The reference numerals are kept the same in the disclosure wherever applicable for ease of explanation.

FIG. 3 illustrates an exemplary view of the one or more entity nodes 106-A, 106-B, 106-C, and 106-D of the system 106, according to an embodiment of the present disclosure.

In an embodiment, the one or more entity nodes 106-A, 106-B, 106-C, and 106-D may correspond to the digitally represented functional unit within the system architecture that is configured to perform the one or more roles in response to the predefined event.

As shown in FIG. 3, the one or more entity nodes 106-A, 106-B, 106-C, and 106-D may be categorized as a provider circle 106-A, an emotion circle 106-B, a service circle 106-C, and a payor circle 106-D.

In an embodiment, the provider circle 106-A may correspond to entities responsible for delivering core services or actions in response to the predefined events. In an example, the entities in the provider circle 106-A may include medical professionals in a healthcare system, technicians in a smart infrastructure network, or any agents tasked with executing interventions or supplying goods and services directly to the user.

In an embodiment, the emotion circle 106-B may correspond to entities that manage or influence user sentiment, perception, and behavioral responses. In an example, the entities in the emotion circle 106-B may include family members, friends, relatives, virtual agents designed to provide empathetic interaction, feedback systems that gauge satisfaction, or digital companions aimed at enhancing emotional well-being during service delivery.

In an embodiment, the service circle 106-C may correspond to functional units responsible for orchestrating, coordinating, or managing the delivery and logistics of the services involved. The service circle 106-C may ensure that services are aligned with the requirements of the predefined event, optimizing timing, resources, and communication across the ecosystem to maintain efficiency and quality.

In an embodiment, the payor circle 106-D may correspond to entities that handle financial dimension of the ecosystem, including funding, billing, and cost reconciliation. In an example, the entities of the payor circle 106-D may include insurance systems, digital wallets, or payment processors that ensure services rendered are properly compensated and that financial workflows adhere to policy and regulatory standards.

In an example scenario of a health ecosystem, an elderly patient, “Mr. S” may experience a sudden spike in heart rate at home, which is detected by the sensing device. The detection may trigger the predefined event within the system 106, thereby activating a coordinated, multi-layered response involving four functional circles: the provider circle 106-A, the emotion circle 106-B, the service circle 106-C, and the payor circle 106-D.

Initially, the provider circle 106-A may respond first, where a telehealth physician may be alerted through the system 106, and a video consultation may be initiated. Simultaneously, a mobile health unit may be dispatched to “Mr. S's” location, and a remote paramedic may be placed on standby to deliver physical care if necessary.

Meanwhile, the emotion circle 106-B may be engaged by activating a virtual emotional support agent that may communicate with “Mr. S” to help manage anxiety, offering calming prompts and real-time reassurance. Further, “Mr. S's” daughter may also be notified through a companion application, enabling her to provide comfort remotely via a live call.

Further, the service circle 106-C may ensure a secure connection for the video consultation, send “Mr. S's” medical history to the telehealth physician, and unlock Mr. S's smart home door temporarily for emergency access.

Furthermore, the payor circle 106-D may verify “Mr. S's” insurance coverage, calculate the cost of the emergency response, and process payment or initiate claim submission. Thus, the system 106 may ensure that “Mr. S” receives timely care, emotional support, efficient service delivery, and hassle-free financial processing, specifically during emergency scenarios.

FIGS. 4A-4D illustrate an exemplary exploded view of the multi-layered ecosystem of the system 106, according to an embodiment of the present disclosure.

The processor 202 may establish a communication link with the ecosystem encapsulator device 104. The connection enables the processor 202 to access data associated with the subject node 102 via the sensing device. The processor 202 may analyse the data from the sensing device (or the sensing device input) in real-time, and when the data exceeds the predefined threshold indicative of the emergency scenario, the processor 202 may initiate the predefined event within the system 106. Accordingly, the processor 202 may activate the provider circle 106-A, the emotion circle 106-B, the service circle 106-C, and the payor circle 106-D. The multi-layered design of the ecosystem is managed by the system 106 using the processor 202 may include hierarchical response layers and multiple service domains, that may enable an intelligent, user-centered progression from core intervention to auxiliary and emotional support functionalities.

FIG. 4A illustrates an exploded view of the multi-layered service ecosystem of the system 106 comprising the provider circle 106-A and the service circle 106-C, each including one or more entity nodes configured to respond to the predefined event, for instance, as a health disorder.

In the exemplary scenario of the health disorder, the exploded view of the multi-layered service ecosystem of the system 106 may include the plurality of ecosystem layers such as a primary layer 106-E, a secondary layer 106-F, and a tertiary layer 106-G, which collectively enable a progressive, role-based response structure based on the nature and urgency of the predefined event.

The processor 202, on the occurrence of the health disorder event, may allow the user to interact with the ecosystem and initiate contact by selecting the provider circle 106-A, as shown in FIG. 4B.

In response, the processor 202 may dynamically expand the provider circle 106-A into two verticals: a physician node 402-B and a care coordinator node 404-B, each representing a distinct functional role within the ecosystem. For instance, the physician node 402-B may be configured to provide immediate diagnostic consultation by the physician, while the care coordinator node 404-B may facilitate logistical support and care planning.

As shown in FIG. 4C, the user may further engage with the ecosystem by selecting the primary layer 106-E, triggering the processor 202 to reveal an additional vertical node labeled surgeon 402-C. The surgeon node 402-C may indicate availability for critical intervention procedures that may be necessary based on the physician's assessment. The hierarchical expansion reflects the ecosystem's capability to escalate the service response based on context-sensitive triggers.

As shown in FIG. 4D, upon further evaluation, the user or care coordinator may access the secondary layer 106-F, which may dynamically reveal a peer coach node 402-D. The peer coach node 402-D may represent a secondary-tier support entity designed to provide motivational guidance, adherence support, and behavioral reinforcement post-diagnosis or post-procedure.

Further, the service circle 106-C may operate in parallel and is configured to coordinate auxiliary operations, including transportation logistics, appointment scheduling, and digital document exchange. The service circle 106-C may also contain internal nodes (not shown) responsible for coordinating between layers to ensure timely escalation and resource allocation.

FIG. 5 illustrates an example architecture 500 depicting the ANN in metaverse, the metaverse object 108, and an event network on the metaverse, according to an embodiment of the present disclosure. The ANN using the encapsulator device may be configured to generate a dynamic profile of the subject node by processing data acquired from the sensing device, blockchain-based data sources, and artificial intelligence or virtual intelligence (AI/VI)-based patient assessments. The ANN may be further configured to dynamically establish interconnections among the one or more entity nodes 106-A, 106-B, 106-C, and 106-D distributed across the plurality of ecosystem layers 106-E, 106-F, and 106-G, thereby constructing an event response network tailored to the subject node's evolving condition.

The example architecture of the system 106 includes the ANN on the metaverse, the metaverse object 108 as a wellness ecosystem encapsulator, and an event network on the metaverse.

The ANN on the metaverse models relationships among the nodes such as micro cohorts, micro KPIs, care moments, vendor categories, risk events, and micro services. The nodes may be interconnected via calculated weights or weighted edges. The weights indicate influence values or prioritization factors. In an embodiment, the ANN variables and weights are dynamically modifiable by a user or administrator node to configure a subject-specific event response network. In an embodiment, the system 106 further may include functionality for receiving the interaction from the subject. The interaction may indicate the request for visualization, filtering, or navigation through the multi-dimensional annotation of the metaverse object. The interaction may be based on selected dimensional parameters or a time sequence of triggered transactions, such as care events or service escalations. The interaction may enable the subject to explore the ANN-generated topology and weighted pathways of the ANN, thereby facilitating personalized insights, contextual awareness, or decision support within the metaverse. For example, activating a care level node with an increased weight may increase the sensitivity of the system 106 to behavioral anomalies in the subject node.

Further, the wellness ecosystem encapsulator implemented as the metaverse object 108, and visualized as the n×n×n cube. The cube encapsulates the subject node (e.g., a patient or user) and represents a plurality of ecosystem layers including the one or more entity nodes such as provider circle, emotions circle, services circle, and payor circle. Furthermore, the visible unit of the cube represents a contextualized data point such as “drug adherence”, “lifestyle discipline” and may be mapped across time (e.g., Month 2, Month 3). The mappings may be derived from dimensional parameters, including the cohort identifier, the KPI, the service level score, the risk level, and the metaverse interaction point value.

The cube may also be annotated with multi-dimensional annotations, which provide a visual representation of the transaction context triggered in response to a detected event and corresponding dimensional parameters. The annotations may include one or more of: the identity or role of the entity nodes involved in the transaction, the event type, and the associated dimensional parameter values. Each annotation may be linked to a cryptographically generated hash to ensure verifiability and traceability of the event, forming part of a tamper-evident event ledger on the blockchain network 110.

The event network in the metaverse includes the patient node surrounded by multiple service provider nodes and associated contextual events. For example, fasting, travel, stressful day, moments of loss, and unanticipated events. The predefined events may be detected from one or more subject parameters received via sensing devices (e.g., biometric sensors, cameras, voice inputs). The subject parameters are processed to indicate physiological, behavioral, or contextual states, which are analyzed to detect a predefined event.

Consequently, in response to the detected event, the system 106 may be configured to trigger at least one transaction across entity nodes within the relevant ecosystem layer. The triggered transaction, dimensional parameters, and their corresponding visual annotations are encapsulated and updated within the metaverse object 108 (the cube), thereby enabling real-time or retrospective analysis of ecosystem responsiveness. In an advantageous aspect, the example architecture 600 provides a verifiable, blockchain enabled visualization, and control environment for enhancing wellness interventions or service coordination within the subject's ecosystem.

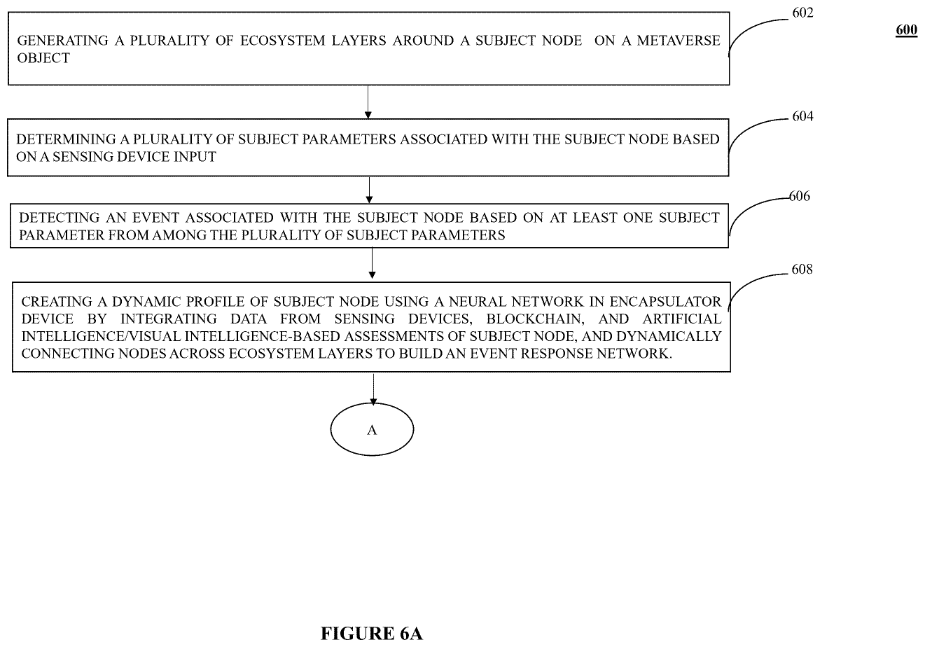

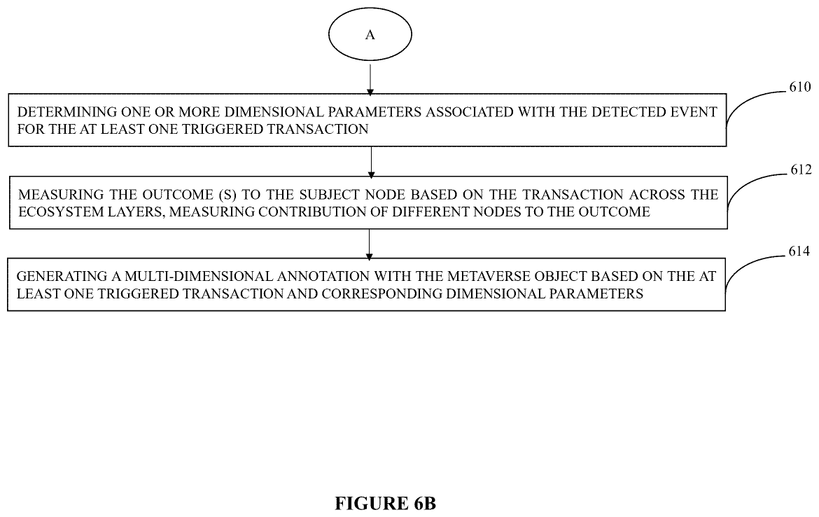

FIGS. 6A-6B illustrate a process flow of a method for managing multi-layered ecosystem responses to predefined events, according to an embodiment of the present disclosure.

The method 600 may be a computer-implemented method executed, for example, by the system 106 and/or the processor 202. For the sake of brevity, constructional and operational features of the system 106 that are already explained in the description of FIG. 1, FIG. 2, FIG. 3, FIGS. 4A-4D, and FIG. 5 are not explained in detail in the description of FIGS. 6A-6B.

At step 602, the method 600 may include generating the plurality of ecosystem layers around the subject node on the metaverse object 108. In a non-limiting example, each of the plurality of ecosystem layers 106-E, 106-F, and 106-G may comprise one or more entity nodes 106-A, 106-B, 106-C, and 106-D.

In a non-limiting example, the subject node may correspond to the designated digital entity, data point, or interaction anchor within the metaverse object 108 that serves as the focal point for generating or associating ecosystem layers. The subject node may be the user avatar, virtual asset, interaction event, or computational process, and is configured to receive, transmit, or process data across the plurality of ecosystem layers.

In an embodiment, the metaverse object 108 may correspond to the digitally instantiated entity within a simulated, immersive, or extended reality environment. For instance, the metaverse object 108 may include, but is not limited to, avatars, virtual assets, interactive elements, spatial constructs, or encoded digital tokens.

In a non-limiting example, the one or more entity nodes 106-A, 106-B, 106-C, and 106-D may correspond to the digitally represented functional unit within the system architecture that is configured to perform one or more roles in response to the predefined event. Each of the one or more entity nodes 106-A, 106-B, 106-C, and 106-D may correspond to distinct stakeholder, service, or data source within the plurality of ecosystem layers 106-E, 106-F, and 106-G, and may be operable to transmit, receive, process, or store information relevant to the predefined event context. In an embodiment, each entity node 106-A, 106-B, 106-C, and 106-D may be dynamically linked to the subject node and may participate in generating or interacting with the plurality of ecosystem layers on the metaverse object 108.

Further, in a non-limiting example, the metaverse object 108 may include the n×n dimensional encapsulated 3D structure configured to represent the plurality of ecosystem layers 106-E, 106-F, and 106-G and interconnections among the one or more entity nodes 106-A, 106-B, 106-C, and 106-D.

At step 604, the method 600 may include determining a plurality of subject parameters associated with the subject node based on a sensing device input. In a non-limiting example, the subject parameters may indicate one or more of physiological, behavioral, or contextual states of the subject node.

In a non-limiting example, the sensing device may comprise at least one of the wearable biometric sensor, the video capture device, the voice recognition device, or the environmental monitor communicably coupled to the ecosystem encapsulator device 104.

At step 606, the method 600 may include detecting the event associated with the subject node based on at least one subject parameter from among the plurality of subject parameters.

At step 608, the method 600 may include creating the dynamic profile of subject node, using the neural network, in encapsulator device by integrating data from the sensing device, blockchain, and artificial intelligence/visual intelligence-based assessments of the subject node, and dynamically connecting the one or more nodes 106-A, 106-B, 106-C, and 106-D across the plurality of ecosystem layers 106-E, 106-F, and 106-G to build the event response network. In an embodiment, the method 600 may include triggering, based on the detected event, the at least one transaction across the one or more entity nodes in the corresponding ecosystem layer in the plurality of ecosystem layers 106-E, 106-F, and 106-G. In a non-limiting example, the at least one transaction indicates the responsive action, communication, or resource exchange initiated among the one or more entity nodes 106-A, 106-B, 106-C, and 106-D.

At step 610, the method 600 may include determining the one or more dimensional parameters associated with the detected event for the at least one triggered transaction. In a non-limiting example, the one or more dimensional parameters may comprise at least one of the cohort identifier, the key performance indicator (KPI), the service level score, the risk level, and the metaverse interaction point value.

At step 612, the method 600 may include measuring outcome to the subject node based on the transaction across the plurality of ecosystem layers 106-E, 106-F, and 106-G, measuring contribution of the one or more nodes 106-A, 106-B, 106-C, and 106-D to the outcome.

At step 614, the method 600 may include generating the multi-dimensional annotation with the metaverse object 108 based on the at least one triggered transaction and corresponding dimensional parameters. In a non-limiting example, the multi-dimensional annotation may indicate the cryptographically linked visual representation, thereby ensuring the integrity and traceability of the visualized multi-layered ecosystem on the blockchain network 110.

In an embodiment, the method 600 may include generating the hash of the at least one triggered transaction and the corresponding dimensional parameters. In a non-limiting example, the hash may indicate the cryptographically verifiable reference to the event, ensuring data integrity and non-repudiation.

In an embodiment, the method 600 may include storing the hash on the blockchain network 110 to register the predefined event.

In an embodiment, to determine the plurality of subject parameters, the method 600 may include receiving at least one of the temporal or the spatial data captured by the at least one sensing device. Further, the method 600 may include determining at least one of the biometric signal, the behavioral pattern, or the environmental condition associated with the subject node based on the at least one of the temporal or spatial data.

In an embodiment, the method 600 may include receiving the interaction from the subject. In a non-limiting example, the interaction may indicate visualization, filtering, or navigation through the multi-dimensional annotation based on selected dimensional parameters or the time sequence of triggered transactions in the metaverse object 108. In a non-limiting example, the subject may correspond to the human user, digital agent, or autonomous entity that engages with one or more components of the multi-layered ecosystem.

In an embodiment, the method 600 may include receiving the modification from the subject. In a non-limiting example, the modification may indicate adjusting the transaction context represented in the multi-dimensional annotation on the metaverse object 108. Further, the method 600 may include managing the one or more neural network variables, connections, or weight values associated with the plurality of ecosystem layers of the artificial neural network configured within the ecosystem encapsulator device 104 to modify the transaction context.

In an embodiment, the method 600 may include generating the new capability for the one or more entity nodes within the corresponding ecosystem layer. Further, the method 600 may include updating the metaverse object 108 and the corresponding dimensional parameters, thereby reflecting the improved service level of the one or more entity nodes 106-A, 106-B, 106-C, and 106-D.

The present disclosure provides various technical advantages:

a) The present disclosure facilitates prioritization of emergency services over routine service requests.
b) The present disclosure provides real-time data exchange between emergency responders and other service providers.
c) The present disclosure provides contextual awareness, enabling the system to adapt dynamically based on the nature and severity of the emergency.
d) The present disclosure provides scalability and modularity, allowing the ecosystem to evolve and integrate new services without compromising emergency response capabilities.
e) The present disclosure further provides for administrative control over an emergency response network by allowing administrators to perform multidimensional analysis and segmentation of the network across an n×n dimensional framework, thereby facilitating future modifications for improved outcome efficacy.

While specific language has been used to describe the present subject matter, any limitations arising on account thereof, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

We claim:

1. A method, implemented on an ecosystem encapsulator device communicably coupled to a blockchain network, for managing multi-layered ecosystem responses to predefined events, the method comprising:
generating a plurality of ecosystem layers around a subject node on a metaverse object, wherein each of the plurality of ecosystem layers comprises one or more entity nodes;
determining a plurality of subject parameters associated with the subject node based on a sensing device input, wherein the subject parameters indicate one or more of physiological, behavioral, or contextual states of the subject node;
detecting an event associated with the subject node based on at least one subject parameter from among the plurality of subject parameters;
triggering, based on the detected event, at least one transaction across the one or more entity nodes in a corresponding ecosystem layer in the plurality of ecosystem layers, wherein the at least one transaction indicates a responsive action, communication, or resource exchange initiated among the one or more entity nodes;
determining one or more dimensional parameters associated with the detected event for the at least one triggered transaction; and
generating a multi-dimensional annotation with the metaverse object based on the at least one triggered transaction and corresponding dimensional parameters, wherein the multi-dimensional annotation indicates cryptographically linked visual representation thereby ensuring integrity and traceability of visualized multi-layered ecosystem on the blockchain network.

2. The method of claim 1, further comprising:
generating a hash of the at least one triggered transaction and the corresponding dimensional parameters, wherein the hash indicates a cryptographically verifiable reference to the event, ensuring data integrity and non-repudiation; and
storing the hash on the blockchain network to register the predefined event.

3. The method of claim 1, wherein the one or more dimensional parameters comprise at least one of: a cohort identifier, a key performance indicator (KPI), a service level score, a risk level, and a metaverse interaction point value.

4. The method of claim 1, wherein determining the plurality of subject parameters comprises:
receiving at least one of temporal or spatial data captured by the at least one sensing device; and
determining at least one of a biometric signal, a behavioral pattern, or an environmental condition associated with the subject node based on the at least one of temporal or spatial data.

5. The method of claim 1, wherein the metaverse object comprises an n×n dimensional encapsulated 3D structure configured to represent the plurality of ecosystem layers and interconnections among the one or more entity nodes.

6. The method of claim 1, further comprising:
receiving an interaction from a subject, wherein the interaction indicates visualization, filtering, or navigation through the multi-dimensional annotation based on selected dimensional parameters or a time sequence of triggered transactions in the metaverse object.

7. The method of claim 1, further comprising:
receiving a modification from the subject, wherein the modification indicates adjusting the transaction context represented in the multi-dimensional annotation on the metaverse object; and
managing one or more neural network variables, connections, or weight values associated with the plurality of ecosystem layers of an artificial neural network configured within the ecosystem encapsulator device to modify the transaction context.

8. The method of claim 1, further comprising:
generating a new capability for the one or more entity nodes within the corresponding ecosystem layer; and
updating the metaverse object and the corresponding dimensional parameters thereby reflecting an improved service level of the one or more entity nodes.

9. The method of claim 1, wherein the sensing device comprises at least one of a wearable biometric sensor, a video capture device, a voice recognition device, or an environmental monitor communicably coupled to the ecosystem encapsulator device.

10. A system, implemented on an ecosystem encapsulator device communicably coupled to a blockchain network, for managing multi-layered ecosystem responses to predefined events, the system comprising:
a memory;
at least one processor in communication with the memory, the at least one processor configured to:
generate a plurality of ecosystem layers around a subject node on a metaverse object, wherein each of the plurality of ecosystem layers comprises one or more entity nodes;
determine a plurality of subject parameters associated with the subject node based on a sensing device input, wherein the subject parameters indicate one or more of physiological, behavioral, or contextual states of the subject node;
detect an event associated with the subject node based on at least one subject parameter from among the plurality of subject parameters;
trigger, based on the detected event, at least one transaction across the one or more entity nodes in a corresponding ecosystem layer in the plurality of ecosystem layers, wherein the at least one transaction indicates a responsive action, communication, or resource exchange initiated among the one or more entity nodes;
determine one or more dimensional parameters associated with the detected event for the at least one triggered transaction; and
generate a multi-dimensional annotation with the metaverse object based on the at least one triggered transaction and corresponding dimensional parameters, wherein the multi-dimensional annotation indicates cryptographically linked visual representation thereby ensuring integrity and traceability of visualized multi-layered ecosystem on the blockchain network.

11. The system as claimed in claim 10, the at least one processor configured to:
generate a hash of the at least one triggered transaction and the corresponding dimensional parameters, wherein the hash indicates a cryptographically verifiable reference to the event, ensuring data integrity and non-repudiation; and
store the hash on the blockchain network to register the predefined event.

12. The system as claimed in claim 10, wherein the one or more dimensional parameters comprise at least one of: a cohort identifier, a key performance indicator (KPI), a service level score, a risk level, and a metaverse interaction point value.

13. The system as claimed in claim 10, wherein to determine the plurality of subject parameters, the at least one processor configured to:
receive at least one of temporal or spatial data captured by the at least one sensing device; and
determine at least one of a biometric signal, a behavioral pattern, or an environmental condition associated with the subject node based on the at least one of temporal or spatial data.

14. The system as claimed in claim 10, wherein the metaverse object comprises an n×n dimensional encapsulated 3D structure configured to represent the plurality of ecosystem layers and interconnections among the one or more entity nodes.

15. The system as claimed in claim 10, the at least one processor configured to:
receive an interaction from a subject, wherein the interaction indicates visualization, filtering, or navigation through the multi-dimensional annotation based on selected dimensional parameters or a time sequence of triggered transactions in the metaverse object.

16. The system as claimed in claim 10, the at least one processor configured to:
receive a modification from the subject, wherein the modification indicates adjusting the transaction context represented in the multi-dimensional annotation on the metaverse object; and
manage one or more neural network variables, connections, or weight values associated with the plurality of ecosystem layers of an artificial neural network configured within the ecosystem encapsulator device to modify the transaction context.

17. The system as claimed in claim 10, the at least one processor configured to:
generate a new capability for the one or more entity nodes within the corresponding ecosystem layer; and
update the metaverse object and the corresponding dimensional parameters thereby reflecting an improved service level of the one or more entity nodes.

18. The system as claimed in claim 10, wherein the sensing device comprises at least one of a wearable biometric sensor, a video capture device, a voice recognition device, or an environmental monitor communicably coupled to the ecosystem encapsulator device.
